(19) United States
(12) Patent Application Publication
(10) Pub. No.: US 2007/0094734 A1
(43) Pub. Date: Apr. 26, 2007

(54) MALWARE MUTATION DETECTOR

(76) Inventors: William H. Mangione-Smith, Kirkland, WA (US); Vwani P. Roychowdhury, Los Angeles, CA (US); Jesse S.A. Bridgewater, Los Angeles, CA (US)

Correspondence Address: Vista IP Law Group LLP;9th Floor, 2040 Main Street, Irvine, CA, 92614, US

(21) Appl. No.: 11/537,443

(22) Filed: Sep. 29, 2006

Related U.S. Application Data
(60) Provisional application No. 60/721,639, filed on Sep. 29, 2005.

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

A method for classifying polymorphic computer software by extracting features from a suspect file and comparing the extracted features to features of known classes of software.

### REFERENCE TO RELATED APPLICATIONS

This application claims priority to U.S. Provisional Patent Application No. 60/721,639 (“the '639 Provisional Application”), filed Sep. 29, 2005, titled “Polymorphic Software Identification”. The contents of the '639 Provisional Application are incorporated by reference as if set forth fully herein.

### FIELD OF THE INVENTION

The present invention relates generally to the detection of polymorphic software, and in a preferred embodiment to the detection of polymorphic computer software threats.

### BACKGROUND OF THE INVENTION

The computing industry is constantly battling to detect and disable software designed for malicious purposes. We refer to all such malicious software as “malware,” and this includes, but is not limited to, viruses, worms, backdoors, Trojan Horses, and combinations thereof. The most common method of detecting malware is known as signature matching, which involves identifying a unique fingerprint associated with a particular malware or set of malware, and then checking a suspect file for the known fingerprint. Typically, the signatures are simple strings or regular expressions.

However, malware authors have developed methods to circumvent signature matching by creating malware that changes its form, or mutates, from one instance to another. We refer to this as polymorphism. Malware authors may create various mutations of a particular malware by using a mutation engine, which is software that transforms/mutates an original malware (referred to herein as a parent malware) into a new malware (referred to herein as a child malware) to avoid signature matching, but nonetheless ensures the child malware maintains the malicious functionality of the parent malware. Various methods of this mutation include: basic block randomization; basic block splitting; decoy instruction insertion; decoy basic block insertion; peephole transformations; constant hiding; subroutine synthesis; branch target hiding; spectrum modification, and entry point obscuring. Known mutation engines include ADMmutate, CLET, and JempiScodes. We believe the first fully polymorphic WINDOWS 32-bit malware was the Win95/Marburg virus released in 1998. Although polymorphism has manifested itself to date most often in viruses, other types of malware may also be polymorphic. For example, Agobot (also known as Gaobot or Phatbot) is a known polymorphic worm.

The software security industry has responded to polymorphic threats by using a process sometimes referred to as “generic decryption”, in which emulators are used to allow execution and inspection of suspect files in a controlled environment. Basically, a software model of an operating environment is developed, and the suspect file (potential malware) is then run in the model environment where the emulator monitors its execution. But this approach is typically difficult to implement in practice and relatively easy to circumvent. For example, the emulation may be cost-prohibitive. Additionally, the malware may be able to detect that it is running in an emulated environment and therefore terminate before delivering its payload. As such, a mutation detector may never identify the signature, and erroneously conclude the suspect malware is not a threat.

A promising approach to identifying polymorphic software has been developed by researchers at the University of Wisconsin, in which the structural attributes of a particular polymorphic attack are characterized by an automaton. The suspect file is analyzed, and the basic blocks and control flow path are determined. The instructions are then annotated with semantic information, and the control flow path and control tree are compared to the automaton that characterized the specific malware. This approach has the potential to undo the effects of some of the malware community's circumvention techniques (e.g., peephole transformations, basic block randomization, and decoy basic block insertion), but requires significant computation time, and also requires each polymorphic threat to be manually characterized.

Therefore, an alternative malware mutation detector is desirable to enable the computer security industry to identify polymorphic malware.

### SUMMARY OF THE INVENTION

The present invention includes a method for classifying/categorizing polymorphic computer software by extracting features from a suspect file, and comparing the extracted features to features of known classes of software (e.g., known malware). In essence, a suspect file is remapped into a feature space thereby allowing classification of the suspect file by comparison of selected features from the suspect file to the features of known files in the feature space. For practical use, an effective mutation detector should have low false positive and low false negative. We have found that with the features identified herein, and based on Bayesian classification techniques, our invention meets these requirements.

The process of our invention attempts to overcome various mutation engine camouflage techniques (described herein), so that the features extracted represent the true functionality of the suspect file. A preferred embodiment of the method of the present invention begins by converting the suspect file into high-level code (such as assembly code), from which the basic blocks of code are then constructed. Optional steps, such as applying an inverse peephole transformation to the high-level code, may be used in certain situations. A control flow graph of the basic blocks of code is constructed, and simplified in certain situations, from which a control tree is built. Features are then extracted from the high-level code, and used to classify the suspect file. The features we extract include OPCODE, MARKOV, Data Dependence Graph (DDG), and/or STRUCT, all defined herein.

The present invention may incorporate social networking technology, which may also take advantage of Bayesian classification techniques. This would allow a first network node to query other network nodes for information the other nodes may have about the suspect file, and/or for the other nodes to perform their own independent classification of the suspect file and report back to the first node (and other network nodes). The information may be related only to specific features, and not necessarily include a conclusive classification of the suspect file. Thus, as a new classification feature is determined based on a high reliability match against a new file, the new feature may be distributed across a peer-to-peer or other network, globally increasing the efficiency of the classifications. Furthermore, a mutation engine may be used to generate child malware from a known malware, and features may be extracted from the child malware to further populate the feature space within the parent malware group. This “seeding” of the feature space helps the present invention detect polymorphic malware potentially before it even makes its way into the computing public.

Since the classification engine is preferably based on Bayesian statistics, the actual classification time is relatively low. Furthermore, because of the nature of Bayesian statistics, in this preferred embodiment the data flow analysis used for feature extraction does not need to be exact and conservative. In essence, using Bayesian techniques allows for faster imprecise algorithms may be used.

One aspect of the present invention thus includes: identifying the suspect binary file to be classified; converting the suspect binary file into a high-level code; extracting features from the high-level code; and classifying the suspect binary file into one of a plurality of groups based on the features extracted. In a preferred embodiment the following steps are also performed: constructing basic blocks of code from the high-level code; determining a control flow graph of the basic blocks of code; and building a control tree from the control flow graph. The features may be classified prior to the suspect binary file being classified, and certain techniques (such as inverse peephole transformation, and/or sliding window technique) may be applied to the suspect binary file before constructing its basic blocks. The features list may be sent across a network by a first network node for processing by other network nodes, and then the first network node may receive a response from another network node indicating whether the features list corresponds to any one of a plurality of groups (e.g., known malware), after which the suspect file may be classified based at least partially on the response from the other network node. The result of the classification may then be saved and used for reporting back to other network nodes that may send future queries.

### BRIEF DESCRIPTION OF THE DRAWINGS

FIG. 1 is a flowchart showing a method of the present invention.

FIG. 2 is a typical system diagram of a network that may be used to implement the present invention.

### DETAILED DESCRIPTION OF THE PREFERRED EMBODIMENTS

The method of the present invention is used to classify polymorphic computer software, by extracting features from a suspect file and comparing the extracted features to features of known classes of software. The method produces practical results in part because of the feature space we have defined (i.e., the features we have chosen to extract), and in part based on the use of Bayesian statistics. That is, within accepted probabilities, a child malware exhibits the same set of features as its parent malware. Thus, once a parent malware has been positively identified, its features can be mapped to the feature space and added to the set of known malware within the feature space (or a more specific set, e.g., Malware-X), and a child malware then would likely be identified as such once its features are extracted and compared to the parent malware.

As explained above, the malware community has developed many camouflage techniques in an attempt to help their polymorphic malware avoid detection by signature-matching mutation detectors. Following are some of the mutation engine camouflage techniques that are used or that may be used. This list is not complete, but merely illustrative. These methods may be used in combination and with other methods by malware authors to make signature detection extremely difficult. The methods are:

Basic Block Randomization. This involves randomly reordering the basic blocks of a program, thus potentially breaking apart signatures which span multiple basic blocks in the parent malware. The Win32/Ghost and BadBoy viruses use this technique. Although a “basic block ” is a term of art, briefly we describe it as an “atomic” unit of code, in that it contains only sequential linear code. Thus, a basic block may be simply a single instruction, or a series of consecutive linear instructions. Studies have shown that a typical basic block of code on average includes five instructions.

Basic Block Splitting. This involves splitting a basic block into two or more portions, thus potentially breaking apart signatures which are in a single block in the parent malware.

Decoy Instruction Insertion. This involves inserting useless instructions (i.e., dead code) within an operational instruction sequence of a basic block, thus also potentially breaking apart signatures which are in a single block in the parent malware.

Decoy Basic Block Insertion. This involves inserting useless entire basic blocks, which may impede data flow analysis (discussed herein) of a mutation detector.

Peephole Transformations. This is similar to peephole optimizations used by many compilers, in which short sequences of code within a basic block are replaced with more efficient code. However, in this case the malware author is not concerned about efficiency, but rather simply intends to replace a sequence of code with another functionally equivalent sequence, thus potentially breaking apart signatures which are in a single block in the parent malware.

Constant Hiding. This involves encryption of the constants in the compiler (e.g., using an XOR) combined with the corresponding decrypter in the executable code, to potentially avoid signature detection based on constant identification. The Evol virus uses this technique.

Subroutine Synthesis. This involves extracting a sequence of basic blocks from a program and replacing them placing them in a new subroutine called in their place. This impedes mutation detectors that rely on subroutine analysis.

Branch Target Hiding. This involves generating a custom subroutine containing a table of branch targets within the body of the calling subroutine. The calling subroutine could then replace some or all branch instructions with a call to the new subroutine and provide the index of the appropriate target.

Spectrum Modification. This involves “whitening” the spectral fingerprint of a program by adding compensation code, thus impeding mutation detectors that rely on spectral properties of a program for identification.

Entry point obscuring. Since signature-based detection schemes must perform detailed regular-expression matching against a database with thousands of signatures, some anti-virus software limits its searching to the beginning and end of the suspect files. While most malware originally attached to the beginning or end of a file, more recently malware may reside at any location within a suspect file. Furthermore, the malware may be set to execute at an arbitrary point in time during the program execution.

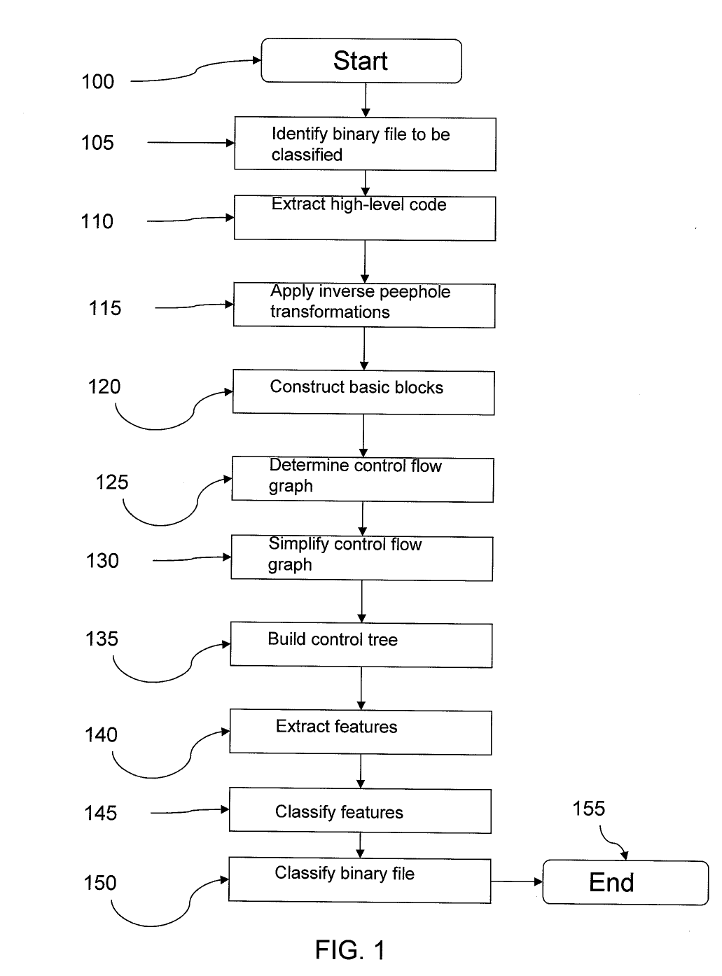

The invention will now be described in detail, in association with the accompanying drawings. Turning to FIG. 1, a flowchart shows a method of classifying a suspect binary file into one of a plurality of groups based on features, according to the present invention. The method starts at step 100, and at step 105 the suspect binary file to be classified is identified. This may be nothing more than having the file available and making a decision to classify the file. At step 110, the suspect binary file is converted into high-level code, or in other words, the high-level code is extracted from the suspect file. Here, high-level refers to any human-cognizable code, including assembly language. Typically this may be performed using a dis-assembler, decompiler, or the like.

Once the high-level code is obtained, an “inverse peephole transformation” step may be optionally performed, as seen at step 115. This process attempts to undo the effects of the mutation engine's peephole transformations. In a theoretical ideal application, all peephole transformations would be undone. However, practically, this is an iterative process that is stopped based upon set criteria such as the number of transformations identified. In a preferred embodiment, the basic blocks of code are then constructed from the high-level code as seen at step 120. Techniques for doing this are known in the art. Although the basic blocks may sometimes be difficult to identify precisely and thoroughly, the construction of the basic blocks can typically be accomplished to an acceptable degree of certainty due to use of Bayesian statistics.

If the basic blocks of code are constructed, a control flow graph of the basic blocks of code may be determined, as seen at step 125. Doing so will help undo many camouflage transformations that may have obscured the control flow path, such as decoy basic block insertion. Although sometimes difficult, this step is well-known in the computer science field and may be accomplished without undue experimentation. The control flow graph may be optionally simplified, as seen at step 130. For example, an initial control flow graph that includes a first instruction after an IF condition and a second instruction after a THEN condition, may be simplified into a graph that includes the first instruction in one instance and the second instruction in the other instance, without regard to which instance results from the IF and which from the THEN, since the distinction is not computationally significant.

If a control flow graph is determined, then at step 135, a control tree may be built from the control flow graph, representing the control structure of the suspect file/program (e.g., accounting for IF-THEN-ELSE constructs, case statements, and the like.) This too may be performed using techniques known in the art. Once the control tree is built, the stage is now set for the features to be extracted from the suspect file. Of course, the stage would be set even after step 110 in certain situations. The features are extracted at step 140, and is explained in more detail below.

Once the features are extracted, then optionally they may be classified, as seen at step 145. The totality of feature classification may then be used to classify the suspect binary file into one of a plurality of groups based on the features extracted, as seen at step 150. Or if the features are not classified themselves, they can nonetheless be used to classify the suspect binary file as a whole at step 150. Classification may be as simple as choosing between two groups—one is known malware and the other is not known malware. Or there may be three groups—known malware, known not to be malware, and unknown. There of course may be any number of groups, which may include numerous individual groups of specific types of malware, and/or numerous groups representing various degrees of confidence that a suspect binary file within the group is or is not malware. The classification process should improve over time as the set of known malware is mapped into the feature space. Thus, each time a new malware is identified by the security industry, it may be mapped into the feature space to further populate the feature space for future classifications. Once the suspect file is classified, the process ends at step 155.

The classification at step 145 may also involve help from other network nodes, e.g., other computers in a network that are participating in the malware detection. For example, in addition to or alternatively from a particular mutation detector performing the classification itself, the mutation detector may send the extracted features (or a subset of them) across a network for evaluation by one or more of its peers. The evaluation at a peer node may then return the result of classification, i.e., an indication as to whether the feature(s) corresponds to any one of a plurality of groups, and the mutation detector may then classify the suspect binary file into one of the plurality of groups based at least partially on the response from the peer node. Of course, the mutation detector may still use the results of its own classification. In either case, the mutation detector may then save the result of the classification, and at a subsequent time when queried by one of its peers as to similar features of a new suspect file, send the result of the classification to the querying peer. The mutation detector may also send the results of the classification out over the network without a query, to help its peers populate their classification database proactively.

Referring back now to step 140, the following features of the suspect file may be extracted: 1) OPCODE; 2) MARKOV; 3) Data Dependence Graph (DDG); and 4) STRUCT. Each of these will now be described. For illustration purposes, presume the following example code sequence from the INTEL IA32 (i.e., x86) instruction set is in a parent polymorphic malware that has already been identified as such:
a. movl % eax, % esi
b. incl % esi
c. incl % eax
d. movb 8132 (% esp, % eax), % al
e. testb % al, % al
f. movl % esi, % eax
g. je.LBBmain_{—}61

OPCODE

We refer to this feature as “OPCODE,” because it considers simply the Op-Codes of the high-level code (i.e., operational instructions without regard to the arguments). Thus, using the example code above, the Op-Codes extracted would be movl, inc, movb, testb, and je. Considering only Op-Codes without regard to arguments helps avoid some mutation engine camouflage techniques in which register use is permutated. Proprietary software may be used for extracting OPCODE features, but such software is known in the art.

The types of consideration may include simply determining whether a specific Op-Code or class of Op-Codes is present, and/or determining the quantitative distribution of each specific Op-Code or class of Op-Codes within the suspect file and/or within each basic block of the suspect file. Using the OPCODE feature has the potential of working well in situations wherein the distribution of Op-Codes is distinct within a particular polymorphic class of malware, which is the case for many real-world polymorphic sets of malware. Furthermore, the computational requirements for extracting the OPCODE feature are very low. Typically, the OPCODE feature will be weighted evenly when used in combination with other features. For example, if the specific OPCODE feature identified is the fact that on average, each basic block of the suspect file contains 2 incl instructions, then the Bayesian classification engine will assign a weight of 1 to that feature. OPCODE does not consider the relative or actual order of the instructions, only their existence and perhaps quantities.

MARKOV

The MARKOV feature is similar to the OPCODE feature in that MARKOV considers Op-codes, but MARKOV further considers the specific order of the Op-codes. This feature is useful because, for example, when a move instruction writes to a register that is then incremented, the move will precede the increment instruction in all mutated versions of the code (child malware), presuming peephole transformations have been undone. Thus, there is an embedded or inherent execution sequence within a malware (and its children malware), and when this sequence is extracted as the MARKOV feature it can then be matched against the sequences that are characteristic of the known polymorphic parent malware.

In a preferred embodiment, the MARKOV features are extracted by first finding all ordering information form the Op-code sequence. For example, starting with the first instruction in the sample code above, there are sequences such as: 1) movl; 2) movl, inc; 3) movl, inc incl; movl, testb; and many others. In fact, in a sequence of n Op-codes, it should be apparent there are 2ⁿ-1 MARKOV features. So using the example code above, which has a sequence of 7 Op-codes, there are 127 MARKOV features. Comparatively, there are only 7 Op-code features counting each Op-code as a feature. Intuitively, the significance of a MARKOV feature should increase with its length, and so we prefer to assign a weight of 2²ⁿ to each MARKOV feature of length n give more weight to longer matches.

Data Dependence Graph

This third type of feature considers the combination of Op-codes and the partial order of them. We refer to this as a “Data Dependence Graph” feature or DDG feature, and it reflects computational structure and relationships inherent in the underlying program code of a suspect file. We consider which instructions produce data values that are read by subsequent instructions. This information is useful about the flow of data through the program computations. Features are extracted by finding a set of graphs in a data dependence graph which are rooted at instructions that are not dependent on any other instructions. Again referring to the sample code above, the two root instructions are a and b. The graph associated with a includes all instructions other than b, while the graph associated with b includes only instructions b and f. Each of the aforementioned graphs implies a partial order among the instructions contained within them. The combination of Op-codes and the partial order of them becomes the DDG feature to use to match against the DDG features of know polymorphic malware.

STRUCT

One limitation of DDG features is that they will not appear in child malware if aggressive basic block splitting is applied. For example, if the basic block shown in the sample parent malware code above is broken after instructions b, c, d, or e, to create a child malware, then neither of the DDG features of the child malware will completely match the parent malware DDG feature for this block. This limitation of the DDG feature motivated the fourth feature which we call STRUCT. STRUCT features are constructed from the entire control flow graph, and thus are able to cross basic block boundaries and negate the impact of basic block splitting. STRUCT also constructs a control tree of the suspect binary file, and extracts features from the tree. The tree is constructed by analyzing the control flow graph and finding logical program structures, such as a sequence of basic blocks, various types of loops, IF-THEN-ELSE statements, and case statements. For example, with this representation it is possible to search for a sequence of five instructions that compute a key identifying function and are known to exist within an arm of a case statement, even if the instructions are artificially divided into multiple basic blocks and the entire case statement contains thousands of instructions.

Thus, using one or more of the above features of a suspect file, either alone or in combination with each other, and assigning various weights to the features which match against a known set of polymorphic malware, we can, using Bayesian techniques, determine to a satisfactory degree of probability whether the suspect file is a child malware of one of the known polymorphic parent malwares for which features have already been extracted.

To overcome the effect of Entry point obscuring, our invention may be implemented using a sliding window technique to extract the features. This technique analyzes the suspect file in portions, i.e., wherein the length of a portion of code being analyzed is considered the window. After a first portion of code is analyzed, then the window slides to the next portion which may overlap the first portion. Preferably the window length remains the same throughout this sliding window technique. In one embodiment, only the most recent 100 features from the suspect file under analysis are maintained. Using this technique, the percent of matching features would likely increase during the analysis of the suspect file when the sliding window was in a position corresponding to the entry point of the child malware. A confidence score may be calculated as log(probability in set)−log(probability not in set), and a low pass filter may be used on the output of a sliding window analysis to achieve even greater overall classification.

As previously described, the present invention may incorporate social networking technology, which may also take advantage of Bayesian classification techniques. This would allow a first network node to query other network nodes for information the other nodes may have about the suspect file, and/or for the other nodes to perform their own independent classification of the suspect file and report back to the first node (and other network nodes). The information may be related only to specific features, and not necessarily include a conclusive classification of the suspect file. Thus, as a new classification feature is determined based on a high reliability match against a new file, the new feature may be distributed across a peer-to-peer or other network, globally increasing the efficiency of the classifications. Furthermore, a mutation engine may be used to generate child malware from a known malware, and features may be extracted from the child malware to further populate the feature space within the parent malware group. This “seeding” of the feature space helps the present invention detect polymorphic malware potentially before it even makes its way into the computing public.

The present invention may be performed manually, or automatically, or using both manual and automatic means. It may be implemented in software, firmware, hardware, or combinations thereof. Here, we use the term “software” to represent all of the aforementioned. The software embodying the present invention may reside on any fixed medium (including computer readable permanent storage), and be executed locally, remotely, over a network, or using any other means available. For example, the software may be implemented on a router/switch in a network, on a PC or device at the end of a wireless network, or at a PC/PDA device at the end of a wireless link.

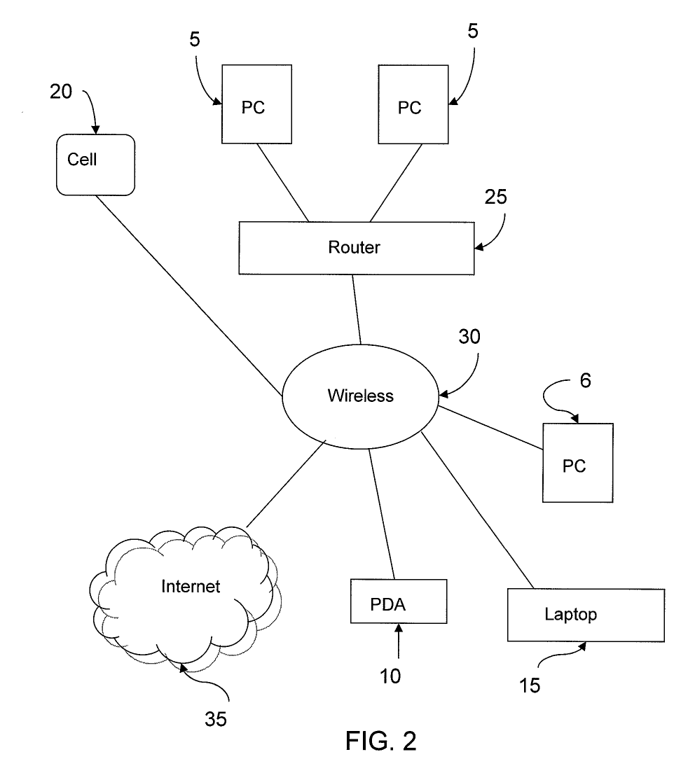

A typical network environment in which the present invention may be implemented is shown in FIG. 2. Generally, the network may be any type of network using any network topology, and may include wireless, wired, intranet, internet, the Internet, a local area network and the like. For example, FIG. 2 shows Personal Computers 5 and 6, PDAs 10, a laptop 15, a cell phone 20, and use of a router 25. All may be connected through a wireless network 30 directly or through other means such as a router 25. The wireless network itself is connected to the Internet 35. We are not aware of any network limitations to implementation of the present invention.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims. As an example, though the methods have been shown and described in reference to malware, the present invention may be used to detect polymorphic software that is not necessarily malware.

What is claimed is:

1. A method of classifying a suspect binary file into one of a plurality of groups based on features, the method comprising:
a) identifying the suspect binary file to be classified;
b) converting the suspect binary file into a high-level code;
c) extracting features from the high-level code; and
d) classifying the suspect binary file into one of a plurality of groups based on the features extracted.

2. The method of claim 1, wherein the features are classified prior to the suspect binary file being classified.

3. The method of claim 1, further comprising the steps of: a) constructing basic blocks of code from the high-level code; b) determining a control flow graph of the basic blocks of code; and c) building a control tree from the control flow graph.

4. The method of claim 3, wherein an inverse peephole transformation is applied to the suspect binary file before the step of constructing basic blocks.

5. The method of claim 3, wherein the control flow graph is simplified before the step of constructing the control tree.

6. The method of claim 1, wherein one of the features is an OPCODE feature.

7. The method of claim 1, wherein one of the features is a MARKOV feature.

8. The method of claim 7, wherein one of the features is an OPCODE feature.

9. The method of claim 8, wherein the MARKOV feature has a length of n and is weighted 2²ⁿ, and the OPCODE feature is weighted evenly.

10. The method of claim 3, wherein one of the features is a Data Dependence Graph feature.

11. The method of claim 3, wherein one of the features is a STRUCT feature.

12. The method of claim 1, wherein one of the plurality of groups corresponds to known malware.

13. The method of claim 1, further comprising the step of using a sliding window technique to extract the features.

14. The method of claim 1, wherein the classifying of the suspect binary file comprises using Bayesian classification techniques.

15. A method of classifying a suspect binary file into one of a plurality of groups based on features, the method comprising:
a) identifying the suspect binary file to be classified;
b) converting the suspect binary file into a high-level code;
c) extracting features from the high-level code to create a features list, said features selected from the group consisting of an OPCODE feature, a MARKOV feature, a Data Dependence Graph feature, and a STRUCT feature;
d) sending the features list to a first network node;
e) receiving a response from the first network node indicating whether the features list corresponds to any one of a plurality of groups; and
f) classifying the suspect binary file into one of the plurality of groups based at least partially on the response from the first network node; and
g) saving a result of the classification.

16. The method of claim 15, further comprising the steps of: a) constructing basic blocks of code from the high-level code; b) determining a control flow graph of the basic blocks of code; and c) building a control tree from the control flow graph.

17. The method of claim 16, wherein one of the plurality of groups corresponds to known malware.

18. The method of claim 17, further comprising sending the result of the classification to a second network node.

19. The method of claim 16, wherein the classifying of the suspect binary file comprises using Bayesian classification techniques.

20. The method of claim 16, wherein the MARKOV feature has a length of n and is weighted 2²ⁿ, whereas the OPCODE feature is weighted evenly.

21. The method of claim 16, further comprising the step of using a sliding window technique to extract the features.

22. Computer software stored on a computer readable medium, programmed to classify a suspect binary file into one of a plurality of groups based on features by performing the following steps:
a) identifying the suspect binary file to be classified;
b) converting the suspect binary file into a high-level code;
c) extracting features from the high-level code; and
d) classifying the suspect binary file into one of a plurality of groups based on the features extracted.

23. The computer software of claim 22, further programmed to: a) construct basic blocks of code from the high-level code; b) determine a control flow graph of the basic blocks of code; and c) build a control tree from the control flow graph.

24. The computer software of claim 22, wherein one of the features is an OPCODE feature.

25. The computer software of claim 22, wherein one of the features is a MARKOV feature.

26. The computer software of claim 23, wherein one of the features is a Data Dependence Graph feature.

27. The computer software of claim 23, wherein one of the features is a STRUCT feature.

28. The computer software of claim 23, wherein one of the plurality of groups corresponds to known malware.

29. The computer software of claim 23, further programmed to use a sliding window technique to extract the features.

30. The computer software of claim 23, wherein the classifying of the suspect binary file comprises using Bayesian classification techniques.
